(19) United States
(12) Patent Application Publication
(10) Pub. No.: US 2015/0379132 A1
(43) Pub. Date: Dec. 31, 2015

(54) SYSTEMS AND METHODS FOR PROVIDING CONTEXT-SPECIFIC MEDIA ASSETS

(71) Applicant: UNITED VIDEO PROPERTIES, INC., Santa Clara, CA (US)

(72) Inventor: Howard Cho, Namyangiu City (KR)

(21) Appl. No.: 14/316,673

(22) Filed: Jun. 26, 2014

(51) Int. Cl. G06F 17/30

(52) U.S. Cl. CPC G06F 17/30867

(57) ABSTRACT

Systems and methods are described herein for providing context specific media assets. A first search criterion may be determined from a text document, wherein the first search criterion indicates a context of the text document. A portion of the text document of interest to the user may be identified, and a second search criterion may be determined that indicates the context of the identified portion. A media source may be searched for media assets related to the first and second search criterion, and the related media asset may be presented to the user.

### BACKGROUND

Today's media consumers are faced with a wide variety of media content, and conventional systems typically provide methods of searching for and presenting media assets. For example, a user who is reading a text document or article may use a search function to enter keywords, and the system may search for and present media assets to the user that are related to the keywords. While these traditional methods of searching for media assets are generally effective at providing related media assets, they require the user to manually determine and enter keywords that are related to the text document and their current interests. Furthermore, the user may be interested only in a specific portion of a text document, and thus, even after retrieving media assets related to the text document, the user must still search the media assets to determine which one is related to the specific portion.

### SUMMARY

Accordingly, systems and methods are described herein for automatically presenting context-specific media assets related to a user's interest in media content. For example, a media guidance application may provide context specific media assets based on a portion of media content that a user is currently consuming. The media guidance application may detect a user's interest in a portion of the content that the user is currently consuming and present media assets that are related to the portion of content. Accordingly, the media guidance application automatically presents media assets to a user that are related to a portion of interest without the user inputting specific search terms.

In some aspects, a media guidance application may first determine, from a media asset, a first search criterion that indicates a context of the media asset. The media guidance application may determine the first search criterion by determining a subject matter of the media asset, a category of the media asset, a genre of the media asset, or a context of the media asset. The media guidance application may further perform a keyword search on the media asset to determine the first search criterion. As an illustrative example, a user may be consuming a media asset related to a basketball game. The media guidance application may determine that the media asset is generally about basketball, the Celtics basketball team, and the Heat basketball team. A first search criterion may comprise the keywords “basketball,” “Celtics,” and/or “Heat.”

The media guidance application may next identify a portion of the media asset of interest to the user, in which the portion of the media asset includes less than all of the media asset. The media guidance application may identify the portion of the media asset in a number of ways. For example, the media guidance application may detect if the user highlights a word, sentence, paragraph, or other subset of the text document using a cursor. Furthermore, the media guidance application may track a user's eye movement using a detection module to determine the presence and direction of a user's gaze and/or which portion of the media asset the user is currently watching or reading. In conjunction with eye tracking, the media guidance application may monitor the user's facial expressions to determine interest, excitement, or other emotions while the user is consuming the media asset.

The media guidance application may determine a second search criterion based on the identified portion of the media asset of interest to the user. The second search criterion may comprise a context of the portion of the media asset and may further comprise a time (e.g., a particular scene, frame, point of playback, etc.) associated with the identified portion of the media asset. To continue the illustrative example from above, the user may have indicated interest in a dunk that occurred in the basketball game at 5 minutes into the 3^{rd} quarter of the game. For example, the user may have exclaimed with joy while reading about or watching the dunk. The second search criterion may include the keyword “dunk,” the name of the player(s) involved, and/or the game time of the occurrence or event.

The media guidance application may search a media source, such as the user's DVR, a networked DVR, a broadcast source, a video-on-demand source, a pay-per-view source, a streaming source, or an Internet media source (e.g., Youtube) for a media asset based on the first search criterion and the second search criterion. In some embodiments, the media guidance application may search the media source automatically without further user input. In some embodiments, the media guidance application may search the media source in response to identifying the portion of the media asset of interest to the user. For example, a search using an Internet search engine may be performed in response to the user highlighting a sentence of a text document. In some embodiments, the media guidance application may retrieve media assets related to the first search criterion and filter the retrieved media assets based on whether the retrieved media assets relate to the second search criterion. In some embodiments, media assets may be weight and/or ranked based on whether or not the media asset meets both the first and second criterion. In some embodiments, the media assets that are related to the second search criterion are a subset of the media assets that relate to the first search criterion. To continue the example from above, the media guidance asset may retrieve media assets related generally to “basketball,” “Celtics,” and “Heat” and filter the results to present only the media assets related to the dunk that occurred 5 minutes into the 3^{rd} quarter of the game.

The media guidance application may present one or more media assets related to the first and second search criterion to the user. In some embodiments, a related media asset may comprise only a portion of a complete media asset. For example, a related media asset may be a clip of a full basketball game. In such embodiments, the media guidance application may crop the complete media asset (or combine multiple cropped media assets) to generate the related media asset. In some embodiments, the user may determine the desired length of such cropped portions, either in real-time or with a prior selection. In embodiments where one of the first or second search criterion includes an identified time, the media guidance application may begin playback of the related media asset at an intermediate time within the related media asset based on the identified time. For example, the media guidance application may fast forward through a complete basketball game to begin playback at 5 minutes into the third quarter (or slightly before) to show the dunk that occurred.

It should be noted that the systems and/or methods described above may be applied to, or used in accordance with, other systems, methods and/or apparatuses.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 shows an illustrative example of a display screen for use in accessing media content in accordance with some embodiments of the disclosure;

FIG. 2 shows another illustrative example of a display screen used access media content in accordance with some embodiments of the disclosure;

FIG. 3 is a block diagram of an illustrative user equipment device in accordance with some embodiments of the disclosure;

FIG. 4 is a block diagram of an illustrative media system in accordance with some embodiments of the disclosure;

FIG. 5 an illustrative example of one component of a detection module, which may be incorporated into, or accessed by, a media application in accordance with some embodiments of the disclosure;

FIG. 6 is a flowchart of illustrative steps for providing context-specific media assets based on a first and second search criterion; and

FIG. 7 is a flowchart of illustrative steps for determining a subset of a text document of interest to a user and presenting a related media asset to the user in accordance with some embodiments of the disclosure.

### DETAILED DESCRIPTION OF THE DRAWINGS

The amount of content available to users in any given content delivery system can be substantial. Consequently, many users desire a form of media guidance through an interface that allows users to efficiently navigate content selections and easily identify content that they may desire. An application that provides such guidance is referred to herein as an interactive media guidance application or, sometimes, a media guidance application or a guidance application.

Systems and methods are described herein for automatically presenting context-specific media assets related to a user's interest in media content. For example, a media guidance application may provide context specific media assets based on a portion of media content that a user is currently consuming. The media guidance application may detect a user's interest in a portion of the content that the user is currently consuming and present media assets that are related to the portion of content. Accordingly, the media guidance application automatically presents media assets to a user that are related to a portion of interest without the user inputting specific search terms.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content or media assets. Interactive media guidance applications may generate graphical user interface screens that enable a user to navigate among, locate and select content. As referred to herein, the terms “media asset” and “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, text documents, playlists, websites, articles, books, electronic books, blogs, advertisements, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

The media guidance application and/or any instructions for performing any of the embodiments discussed herein may be encoded on computer readable media. Computer readable media includes any media capable of storing data. The computer readable media may be transitory, including, but not limited to, propagating electrical or electromagnetic signals, or may be non-transitory including, but not limited to, volatile and non-volatile computer memory or storage devices such as a hard disk, floppy disk, USB drive, DVD, CD, media cards, register memory, processor caches, Random Access Memory (“RAM”), etc.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. Various devices and platforms that may implement media guidance applications are described in more detail below.

In some embodiments, a media guidance application may first determine, from a media asset, a first search criterion that indicates a context of the media asset. As used herein, “context” of the media asset should be understood to mean a description, circumstance, setting, idea, or other information that relates to the media asset. The context may include, but is not limited to, a subject matter of the media asset, a category of the media asset, a genre of the media asset, or a context of the media asset. It should be noted that in embodiments disclosed herein in which the media guidance application determines a context, the media guidance application may additionally or alternatively determine the content of the media asset.

In some embodiments, the context (or content) of a media asset may be expressed as any qualitative or quantitative indicium. For example, the context (or content) may be expressed as a series of keywords found in the media assets or associated with the context (or content), an alphanumeric code or serial number associated with the context (or content), and/or any other indicator.

As used herein, a “search criterion” refers to any criterion used to perform a search. For example, a search criterion may be any keywords, parameters, times, time frames, standards, rules, characteristics, other information used to search for media assets, or any combination of any of the above. It should be noted that any embodiment in featuring the identification of a search criterion may also be applied to an embodiment featuring the identification of search criterion.

The media guidance application may perform a keyword search on the media asset to determine the first search criterion. As an illustrative example, a user may be consuming a media asset related to a movie. The media guidance application may determine that the media asset is generally about a subject matter of “aliens,” has a particular genre, “science fiction,” and/or includes a particular actor, “Tom Cruise.” A first search criterion may comprise the keywords “aliens,” “science fiction,” and “Tom Cruise.”

The media guidance application may then identify a portion of the media asset of interest to the user, in which the portion of the media asset includes less than all of the media asset. A portion of “interest” to the user, as used herein, refers to a portion of a media asset in which the user exhibits a heightened sense of attention, excitement, emotion, attraction, involvement, enjoyment, or another positive emotion in relation to a remainder of the media asset. In some embodiments, the interest of a user in a particular portion may be relative to other portions of the media assets. For example, the media guidance application may determine that the interest of the user for a particular portion of the media asset exceeds a threshold interest associated with the media asset, media assets of the same genre, etc. In some embodiments, the threshold may be determined based on the prior viewing history of a user. For example, the media guidance application may actively or passively monitor the user and calculate levels of interests during various portions of various media assets. In some embodiments, a threshold may be determined by a third party. For example, the media guidance application may retrieve an industry standard associated with levels of interest that trigger particular actions (e.g., the identification of second search criterion).

The media guidance application may identify the portion of the media asset of interest to the user in a number of ways. For example, the media guidance application may detect if the user highlights a word, sentence, paragraph, or other subset of the text document using a cursor. For example, the user may highlight a portion of text with a mouse cursor, thereby indicating an interest in the portion of text. The media guidance application may also track a user's eye movement using a detection module to determine the presence and direction of a user's gaze and/or which portion of the media asset the user is currently watching or reading. In conjunction with eye tracking, the media guidance application may monitor the user's facial expressions to determine interest, excitement, or other emotions while the user is consuming the media asset. As an illustrative example, the media guidance application may determine that the user is reading a particular sentence of a text document, detect that the user's facial expression exhibits excitement, and thereby determine that the particular sentence is of interest to the user.

The media guidance application may determine a second search criterion based on the identified portion of the media asset of interest to the user. In some embodiments, the second search criterion may be narrower or be used to identify a subset of media assets that are related to the first search criterion. The second search criterion may comprise a context of the portion of the media asset of interest to the user. In some embodiments, the second search criterion may further comprise a time associated with the identified portion of the media asset. As an illustrative example, the user may have indicated interest in a criterion scene that occurred in the movie at the thirty minute point in the playback of the movie. For example, the media guidance application may have detected that the user issued a verbal question to another user also viewing the movie. The second search criterion may include a keyword about a current scene (e.g., retrieved from a subtitle), a description of actors currently on screen, a description of plot points of the current scene, etc.

The media guidance application may search a media source, such as the user's DVR, a networked DVR, a broadcast source, a video-on-demand source, a pay-per-view source, a streaming source, or an Internet media source (e.g., Youtube) for a media asset based on the first search criterion and the second search criterion. In some embodiments, the media guidance application may search the media source automatically without further user input. In some embodiments, the media guidance application may search the media source in response to identifying the portion of the media asset of interest to the user. For example, a search on Youtube may be performed in response to the user highlighting a sentence of a text document. In some embodiments, the media guidance application may retrieve media assets related to the first search criterion and filter the retrieved media assets based on whether the retrieved media assets relate to the second search criterion. In some embodiments, the media assets that are related to the second search criterion are a subset of the media assets that relate to the first search criterion. To continue the example from above, the media guidance asset may retrieve media assets related generally to “aliens,” “science fiction,” and “Tom Cruise” and filter the results to present only the media assets related to the current scene.

The media guidance application may present one or more media assets related to the first and second search criterion to the user. In some embodiments, a related media asset may comprise only a portion of a complete media asset. For example, a related media asset may be a clip of the scene, may be additional information about the scene, etc. In such embodiments, the media guidance application may crop the complete movie to generate the related media asset. In some embodiments, the user may determine the desired length of such cropped portions, either in real-time or with a prior selection. In embodiments where one of the first or second search criterion includes an identified time, the media guidance application may begin playback of the related media asset at an intermediate time within the related media asset based on the identified time. For example, the media guidance application may fast forward through the media assets (e.g., director commentary associated with the movie) to begin playback at the portion discussing the scene of user interest (or slightly before).

One of the functions of the media guidance application is to provide media guidance data to users. As referred to herein, the phrase “media guidance data” or “guidance data” should be understood to mean any data related to content or data used in operating the guidance application. For example, the guidance data may include program information, guidance application settings, user preferences, user profile information, media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections.

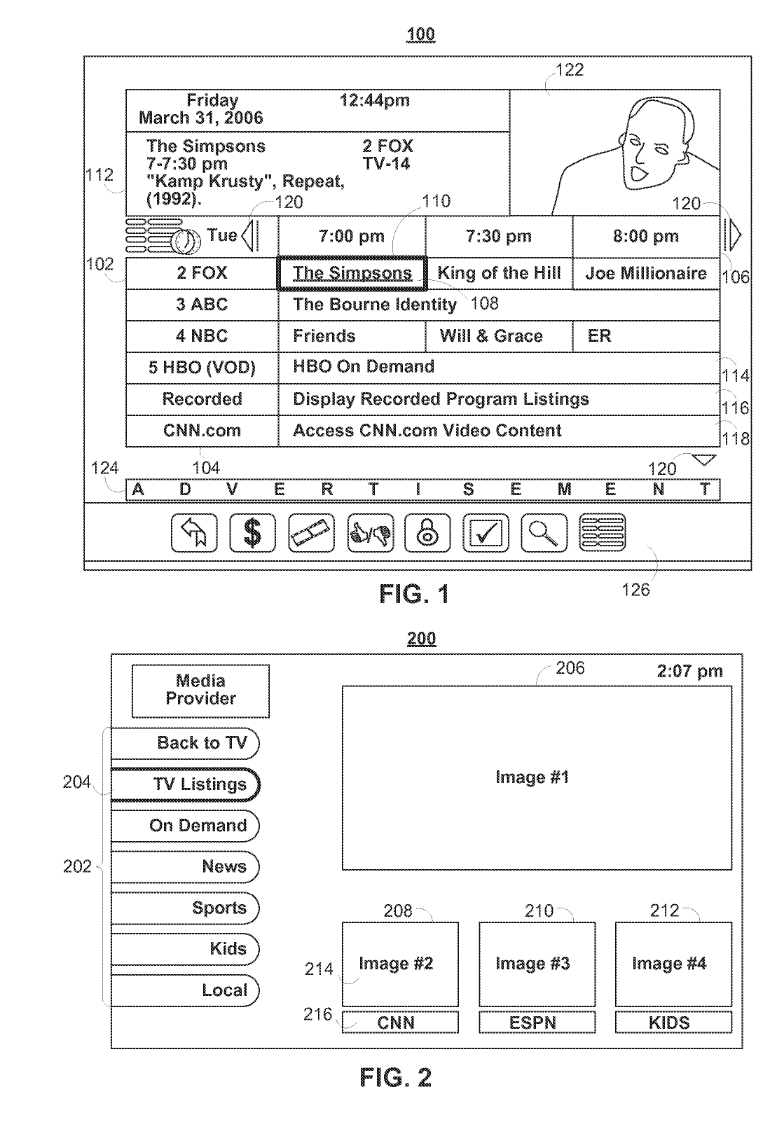

FIGS. 1-2 show illustrative display screens that may be used to provide media guidance data and media assets. The display screens shown in FIGS. 1-2 may be implemented on any suitable user equipment device or platform. While the displays of FIGS. 1-2 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criterion.

FIG. 1 shows illustrative grid program listings display 100 arranged by time and channel that also enables access to different types of content in a single display. Display 100 may include grid 102 with: (1) a column of channel/content type identifiers 104, where each channel/content type identifier (which is a cell in the column) identifies a different channel or content type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L.P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g. FTP).

Grid 102 may provide media guidance data for non-linear programming including on-demand listing 114, recorded content listing 116, and Internet content listing 118. A display combining media guidance data for content from different types of content sources is sometimes referred to as a “mixed-media” display. Various permutations of the types of media guidance data that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 124 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 102. Advertisement 124 may also be for products or services related or unrelated to the content displayed in grid 102. Advertisement 124 may be selectable and provide further information about content, provide information about a product or a service, enable purchasing of content, a product, or a service, provide content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, III et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 126 may allow the user to access different types of content, media guidance application displays, and/or media guidance application features. Options region 126 may be part of display 100 (and other display screens described herein), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other web sites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 4. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 2. Video mosaic display 200 includes selectable options 202 for content information organized based on content type, genre, and/or other organization criterion. In display 200, television listings option 204 is selected, thus providing listings 206, 208, 210, and 212 as broadcast program listings. In display 200 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 208 may include more than one portion, including media portion 214 and text portion 216. Media portion 214 and/or text portion 216 may be selectable to view content in full-screen or to view information related to the content displayed in media portion 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Dec. 29, 2005, which is hereby incorporated by reference herein in its entirety.

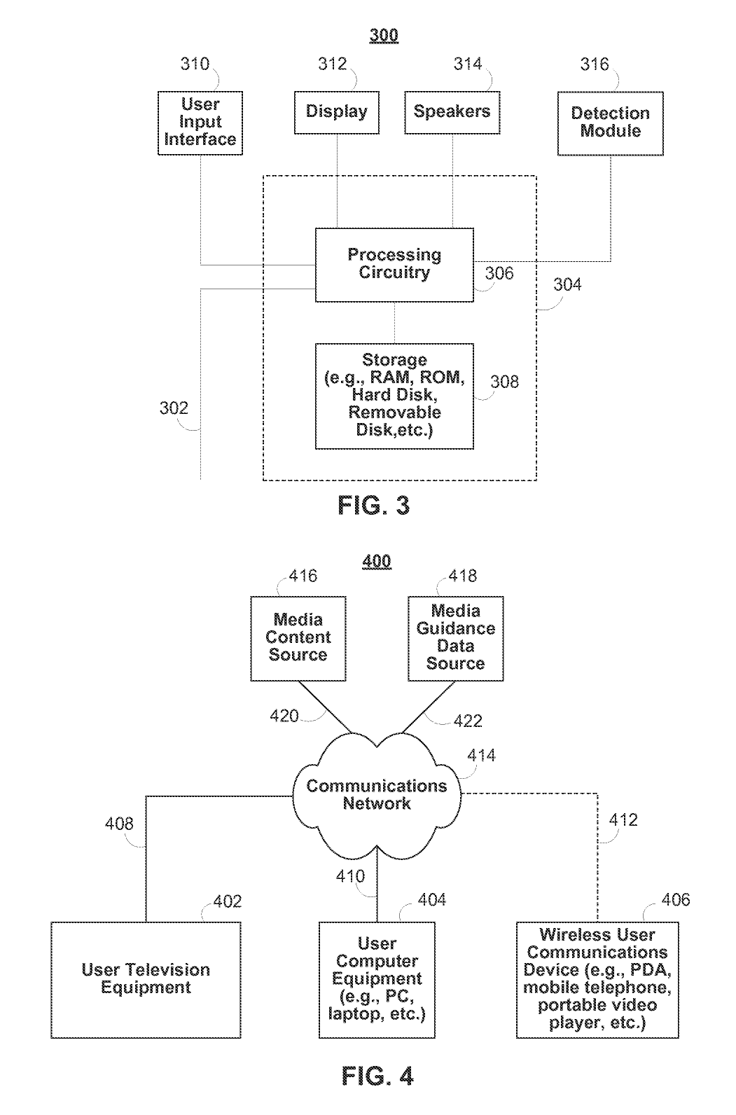

Users may access content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308). Specifically, control circuitry 304 may be instructed by the media guidance application to perform the functions discussed above and below. For example, the media guidance application may provide instructions to control circuitry 304 to generate the media guidance displays. In some implementations, any action performed by control circuitry 304 may be based on instructions received from the media guidance application.

In client-server based embodiments, control circuitry 304 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance data described above. Nonvolatile memory may also be used (e.g., to launch a boot-up routine and other instructions). Cloud-based storage, described in relation to FIG. 4, may be used to supplement storage 308 or instead of storage 308.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may send instructions to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces. Display 312 may be provided as a stand-alone device or integrated with other elements of user equipment device 300. For example, display 312 may be a touchscreen or touch-sensitive display. In such circumstances, user input interface 312 may be integrated with or combined with display 312. Display 312 may be one or more of a monitor, a television, a liquid crystal display (LCD) for a mobile device, amorphous silicon display, low temperature poly silicon display, electronic ink display, electrophoretic display, active matrix display, electro-wetting display, electrofluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

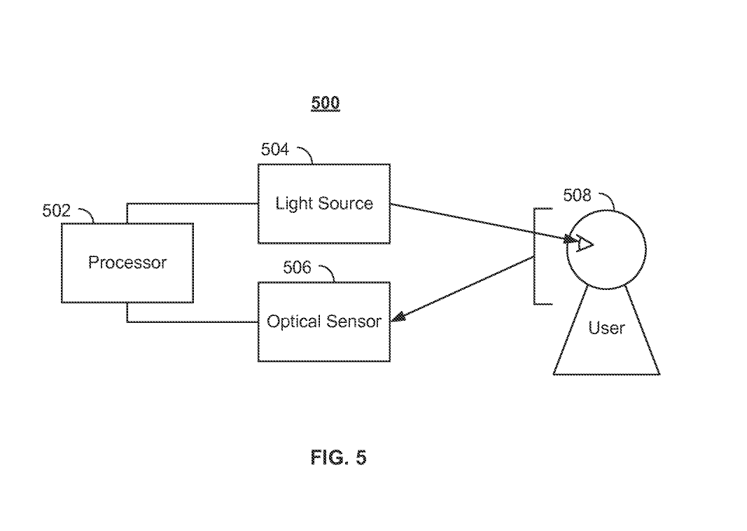

Detection module 316, or the detection module circuitry, may be incorporated into, coupled to, or accessible by the media guidance application (e.g., via control circuitry 304). Detection module 316 may be used to measure, monitor, identify, and determine biometric data and/or a current biometric state of a user. For example, as discussed in further detail in relation to FIG. 5, the detection module 316 may track the eye movement of the user or monitor a user's facial expressions.

In some embodiments, detection module 316 may also monitor physical movement of the user and/or sounds. Detection module 316 may use any suitable sensor to detect movement, including, but not limited to, an optical sensor or an infrared sensor. The movement sensor may detect movement at a specific frequency or framerate, and the frequency or framerate may be either fixed or variable. For example, the movement sensor may detect movement at a first framerate, and in response to detecting movement of a user (e.g., a handwave, a fistpump, or a high-five), the movement sensor may increase the framerate to a second framerate that is higher than the first framerate. The movement sensor may continue to detect movement at the second, increased framerate for a set period of time before reverting to the first framerate. The movement sensor may revert back to the first framerate after a period of time of detecting no movement. In some embodiments, an audio sensor may be used to detect sound from the user or the user's environment. The audio sensor may detect volume, frequency, pitch, tone, or any other audio characteristics. The media guidance application may further be configured with speech recognition software to enable the media guidance application to recognize any words or phrases spoken by the user. As an illustrative example, an increased volume for a short amount of time emanating from the user (e.g., a cheer) in conjunction with increased physical movement (e.g., a first pump) may indicate a user's interest in a particular portion of the media asset that the user is currently watching.

Detection module 316 may further include various components (e.g., a video detection component, an audio detection component, etc.) for determining and/or detecting other types of information. In some embodiments, detection module 316 may include an audio/video detection component, which determines or receives information describing objects in images and/or noise emanating from a user or media asset.

For example, detection module 316 may include one or more content-recognition modules, which may be used by the media guidance application to analyze information received from a content capture device (e.g., video and/or audio recorder). For example, the media guidance application may include an object recognition module. The object recognition module may use edge detection, pattern recognition, including, but not limited to, self-learning systems (e.g., neural networks), optical character recognition, on-line character recognition (including, but not limited to, dynamic character recognition, real-time character recognition, intelligent character recognition), and/or any other suitable technique or method to determine the objects in and/or characteristics of video and audio recordings. For example, the media guidance application may receive a media asset in the form of a video (e.g., the media asset and/or video of a user viewing the media asset). The video may include a series of frames. For each frame of the video, the media guidance application may use an object recognition module to determine the characteristics associated with each frame (or the media assets as a whole) of the video to determine the context of the media asset or a portion of the media asset or to monitor for user interest in a particular portion of the media asset.

In some embodiments, the content-recognition module or algorithm may also include audio analysis and speech recognition techniques, including, but not limited to, Hidden Markov Models, dynamic time warping, and/or neural networks (as described above) to process audio data and/or translate spoken words into text. The content-recognition module may also use any other suitable techniques for processing audio and/or visual data. For example, the content-recognition module may analyze audio data to determine whether or not a user is talking. Furthermore, the content-recognition module may analyze video and/or audio data to determine the context of the media asset or a portion of the media asset or to monitor for user interest in a particular portion of the media asset.

In addition, the media guidance application may use multiple types of optical character recognition and/or fuzzy logic, for example, when comparing multiple data fields (e.g., as contained in databases described below). For example, after the content-recognition module or algorithm translates video and/or audio recordings into text, the media guidance application (e.g., via control circuitry 304) may cross-reference the translated text with a database (e.g., located at storage 308 or media guidance data source 418 (FIG. 4)) to determine whether or not the translated text corresponds to used to determine the context of the media asset or a portion of the media asset or to monitor for user interest in a particular portion of the media asset.

For example, the media guidance application may arrange the text into data fields and cross-reference the data fields with other data fields (e.g., in a lookup table database) corresponding to possible values associated with a keyword in a media asset, the system may determine two fields and/or values to be identical even though the substance of the data field or value (e.g., two different spellings) is not identical. In some embodiments, the system may analyze particular data fields of a data structure or media asset frame for particular values or text. The data fields could be associated with characteristics, other data, and/or any other information required for the function of the embodiments described herein. Furthermore, the data fields could contain values (e.g., the data fields could be expressed in binary or any other suitable code or programming language).

In some embodiments, detection module 316 may include a Global Positioning System (“GPS”) detection component, which determines or receives information describing the geographic position of a user. For example, the GPS detection component may, additionally or alternatively, determine whether or not the user is viewing a particular media asset (e.g., at a movie theatre) is predisposed to have a particular interest (e.g., based on demographic information, etc.

In some embodiments, detection module 316 may include an Internet access component, which determines or receives information used to determine the context of the media asset or a portion of the media asset or to monitor for user interest in a particular portion of the media asset. For example, the Internet access component may, additionally or alternatively, determine whether or not information on the Internet (e.g., social media updates) indicate the context of the media asset or a portion of the media asset or a user interest in a particular portion of the media asset.

In some embodiments, the media guidance application may receive information from a particular source (e.g., a website, a profile associated with a user, a content provider, a social media network, etc.) for use in determining the context of the media asset or a portion of the media asset or to monitor for user interest in a particular portion of the media asset.

For example, the media guidance application may retrieve a list of friends (e.g., a social network buddy list), contacts (e.g., retrieved from a phone/text message/e-mail account associated with the user), and/or other listings featuring other entities with known associations to the user and obtain information about a media asset such as what portions, if any, were important to one or more plotlines of the media asset, what portions were interesting (or not interesting) to users associated with the current user, what portions may be skipped or fast-forwarded through, etc.

As used herein, a “social network” refers to a platform that facilitates networking and/or social relations among people who, for example, share interests, activities, backgrounds, and/or real-life connections. In some cases, social networks may facilitate communication between multiple user devices (e.g., computers, televisions, smartphones, tablets, etc.) associated with different users by exchanging content from one device to another via a social media server. As used herein, a “social media server” refers to a computer server that facilitates a social network. For example, a social media server owned/operated/used by a social media provider may make content (e.g., status updates, microblog posts, images, graphic messages, etc.) associated with a first user accessible to a second user that is within the same social network as the first user.

The guidance application may be implemented using any suitable architecture. For example, it may be a stand-alone application wholly implemented on user equipment device 300. In such an approach, instructions of the application are stored locally (e.g., in storage 308), and data for use by the application is downloaded on a periodic basis (e.g., from an out-of-band feed, from an Internet resource, or using another suitable approach). Control circuitry 304 may retrieve instructions of the application from storage 308 and process the instructions to generate any of the displays discussed herein. Based on the processed instructions, control circuitry 304 may determine what action to perform when input is received from input interface 310. For example, movement of a cursor on a display up/down may be indicated by the processed instructions when input interface 310 indicates that an up/down button was selected.

In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server. For example, the remote server may store the instructions for the application in a storage device. The remote server may process the stored instructions using circuitry (e.g., control circuitry 304) and generate the displays discussed above and below. The client device may receive the displays generated by the remote server and may display the content of the displays locally on equipment device 300. This way, the processing of the instructions is performed remotely by the server while the resulting displays are provided locally on equipment device 300. Equipment device 300 may receive inputs from the user via input interface 310 and transmit those inputs to the remote server for processing and generating the corresponding displays. For example, equipment device 300 may transmit a communication to the remote server indicating that an up/down button was selected via input interface 310. The remote server may process instructions in accordance with that input and generate a display of the application corresponding to the input (e.g., a display that moves a cursor up/down). The generated display is then transmitted to equipment device 300 for presentation to the user.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 3 may not be classified solely as user television equipment 402, user computer equipment 404, or a wireless user communications device 406. For example, user television equipment 402 may, like some user computer equipment 404, be Internet-enabled allowing for access to Internet content, while user computer equipment 404 may, like some television equipment 402, include a tuner allowing for access to television programming. The media guidance application may have the same layout on various different types of user equipment or may be tailored to the display capabilities of the user equipment. For example, on user computer equipment 404, the guidance application may be provided as a web site accessed by a web browser. In another example, the guidance application may be scaled down for wireless user communications devices 406.

In system 400, there is typically more than one of each type of user equipment device but only one of each is shown in FIG. 4 to avoid overcomplicating the drawing. In addition, each user may utilize more than one type of user equipment device and also more than one of each type of user equipment device.

In some embodiments, a user equipment device (e.g., user television equipment 402, user computer equipment 404, wireless user communications device 406) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes content source 416 and media guidance data source 418 coupled to communications network 414 via communication paths 420 and 422, respectively. Paths 420 and 422 may include any of the communication paths described above in connection with paths 408, 410, and 412. Communications with the content source 416 and media guidance data source 418 may be exchanged over one or more communications paths, but are shown as a single path in FIG. 4 to avoid overcomplicating the drawing. In addition, there may be more than one of each of content source 416 and media guidance data source 418, but only one of each is shown in FIG. 4 to avoid overcomplicating the drawing. (The different types of each of these sources are discussed below.) If desired, content source 416 and media guidance data source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 416 may be the originator of content (e.g., a television broadcaster, a Webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 418 may provide media guidance data, such as the media guidance data described above. Media guidance data may be provided to the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 418 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 418 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 418 may provide user equipment devices 402, 404, and 406 the media guidance application itself or software updates for the media guidance application.

In some embodiments, the media guidance data may include viewer data. For example, the viewer data may include current and/or historical user activity information (e.g., what content the user typically watches, what times of day the user watches content, whether the user interacts with a social network, at what times the user interacts with a social network to post information, what types of content the user typically watches (e.g., pay TV or free TV), mood, brain activity information, etc.). The media guidance data may also include subscription data. For example, the subscription data may identify to which sources or services a given user subscribes and/or to which sources or services the given user has previously subscribed but later terminated access (e.g., whether the user subscribes to premium channels, whether the user has added a premium level of services, whether the user has increased Internet speed). In some embodiments, the viewer data and/or the subscription data may identify patterns of a given user for a period of more than one year. The media guidance data may include a model (e.g., a survivor model) used for generating a score that indicates a likelihood a given user will terminate access to a service/source. For example, the media guidance application may process the viewer data with the subscription data using the model to generate a value or score that indicates a likelihood of whether the given user will terminate access to a particular service or source. In particular, a higher score may indicate a higher level of confidence that the user will terminate access to a particular service or source. Based on the score, the media guidance application may generate promotions and advertisements that entice the user to keep the particular service or source indicated by the score as one to which the user will likely terminate access.

Media guidance applications may be, for example, stand-alone applications implemented on user equipment devices. For example, the media guidance application may be implemented as software or a set of executable instructions which may be stored in storage 308, and executed by control circuitry 304 of a user equipment device 300. In some embodiments, media guidance applications may be client-server applications where only a client application resides on the user equipment device, and server application resides on a remote server. For example, media guidance applications may be implemented partially as a client application on control circuitry 304 of user equipment device 300 and partially on a remote server as a server application (e.g., media guidance data source 418) running on control circuitry of the remote server. When executed by control circuitry of the remote server (such as media guidance data source 418), the media guidance application may instruct the control circuitry to generate the guidance application displays and transmit the generated displays to the user equipment devices. The server application may instruct the control circuitry of the media guidance data source 418 to transmit data for storage on the user equipment. The client application may instruct control circuitry of the receiving user equipment to generate the guidance application displays.

Content and/or media guidance data delivered to user equipment devices 402, 404, and 406 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 400 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices may communicate with each other within a home network. User equipment devices can communicate with each other directly via short-range point-to-point communication schemes described above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 416 to access content. Specifically, within a home, users of user television equipment 402 and user computer equipment 404 may access the media guidance application to navigate among and locate desirable content. Users may also access the media guidance application outside of the home using wireless user communications devices 406 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 414. These cloud resources may include one or more content sources 416 and one or more media guidance data sources 418. In addition or in the alternative, the remote computing sites may include other user equipment devices, such as user television equipment 402, user computer equipment 404, and wireless user communications device 406. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 404 or wireless user communications device 406 having content capture feature. Alternatively, the user can first transfer the content to a user equipment device, such as user computer equipment 404. The user equipment device storing the content uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 3.

FIG. 5 is an illustrative example of one component of a detection module, which may be accessed by a media application in accordance with some embodiments of the disclosure. FIG. 5 shows eye contact detection component 500, which may be used to identify the gaze point of a user of user equipment 300. The gaze point may be used to determine whether the user is currently looking at the user equipment 300 and/or what location on the user equipment 300 the user is looking at. For example, the gaze point may be used to determine that the user is watching a particular portion of a scene of a movie or reading a particular sentence of a text article. Eye contact detection component 500 includes processor 502, light source 504, and optical sensor 506. Light source 504 transmits light that reaches at least one eye of a user, and optical sensor 506 is directed at the user to sense reflected light. Optical sensor 506 transmits collected data to processor 502, and based on the data received from optical sensor 506, processor 502 determines a user's gaze point.

In some embodiments, eye contact detection component 500 is configured for determining a gaze point of a single user. In other embodiments, eye contact detection component 500 may determine gaze points for a plurality of users (e.g., user 102, user 104, user 106, user 108, and user 110 (FIG. 1)). Eye contact detection component 500 may identify multiple users of user equipment device 300.

Processor 502 may be integrated with one or more light sources 504 and one or more optical sensors 506 in a single device. Additionally or alternatively, one or more light sources 504 and one or more optical sensors 506 may be housed separately from processor 502 and in wireless or wired communication with processor 502. One or more of processors 502, light sources 504, and optical sensors 506 may be integrated into user equipment device 300.

Processor 502 may be similar to processing circuitry 306 described above. In some embodiments, processor 502 may be processing circuitry 306, with processing circuitry 306 in communication with light source 504 and optical sensor 506. In other embodiments, processor 502 may be separate from but optionally in communication with processing circuitry 306.

Light source 504 transmits light to one or both eyes of one or more users. Light source 504 may emit, for example, infrared (IR) light, near infrared light, or visible light. The light emitted by light source 504 may be collimated or non-collimated. The light is reflected in a user's eye, forming, for example, the reflection from the outer surface of the cornea (i.e. a first Purkinje image), the reflection from the inner surface of the cornea (i.e. a second Purkinje image), the reflection from the outer (anterior) surface of the lens (i.e. a third Purkinje image), and/or the reflection from the inner (posterior) surface of the lens (i.e. a fourth Purkinje image).

Optical sensor 506 collects visual information, such as an image or series of images, of one or both of one or more users' eyes. Optical sensor 506 transmits the collected image(s) to processor 502, which processes the received image(s) to identify a glint (i.e. corneal reflection) and/or other reflection in one or both eyes of one or more users. Processor 502 may also determine the location of the center of the pupil of one or both eyes of one or more users. For each eye, processor 502 may compare the location of the pupil to the location of the glint and/or other reflection to estimate the gaze point. The gaze point may be used to determine or estimate a location on the display 312 that the user is currently watching. Processor 502 may also store or obtain information describing the location of one or more light sources 504 and/or the location of one or more optical sensors 506 relative to display 312. Using this information, processor 502 may determine a user's gaze point on display 312, or processor 502 may determine whether or not a user's gaze point is on display 312.

In some embodiments, eye contact detection component 500 performs best if the position of a user's head is fixed or relatively stable. In other embodiments, eye contact detection component 500 is configured to account for a user's head movement, which allows the user a more natural viewing experience than if the user's head were fixed in a particular position.

In some embodiments accounting for a user's head movement, eye contact detection component 500 includes two or more optical sensors 506. For example, two cameras may be arranged to form a stereo vision system for obtaining a 3D position of the user's eye or eyes; this allows processor 502 to compensate for head movement when determining the user's gaze point. The two or more optical sensors 506 may be part of a single unit or may be separate units. For example, user equipment device 300 may include two cameras used as optical sensors 506, or eye contact detection component 500 in communication with user equipment device 300 may include two optical sensors 506. In other embodiments, each of user equipment device 300 and eye contact detection component 500 may include an optical sensor, and processor 502 receives image data from the optical sensor of user equipment device 300 and the optical sensor of eye contact detection component 500. Processor 502 may receive data identifying the location of optical sensor 506 relative to display 312 and/or relative to each other and use this information when determining the gaze point.

In other embodiments accounting for a user's head movement, eye contact detection component 500 includes two or more light sources for generating multiple glints. For example, two light sources 504 may create glints at different locations of an eye; having information on the two glints allows the processor to determine a 3D position of the user's eye or eyes, allowing processor 502 to compensate for head movement. Processor 502 may also receive data identifying the location of light sources 504 relative to display 312 and/or relative to each other and use this information when determining the gaze point.

In some embodiments, other types of eye contact detection components that do not utilize a light source may be used. For example, optical sensor 506 and processor 502 may track other features of a user's eye, such as the retinal blood vessels or other features inside or on the surface of the user's eye, and follow these features as the eye rotates. Any other equipment or method for determining one or more users' gaze point(s) not discussed above may be used in addition to or instead of the above-described embodiments of eye contact detection component 500.

It should be noted that eye contact detection component 500 is but one type of component that may be incorporated into or accessible by detection module 316 (FIG. 3) or the media application. Other types of components, which may generate other types of data (e.g., video, audio, textual, etc.) are fully within the bounds of this disclosure.

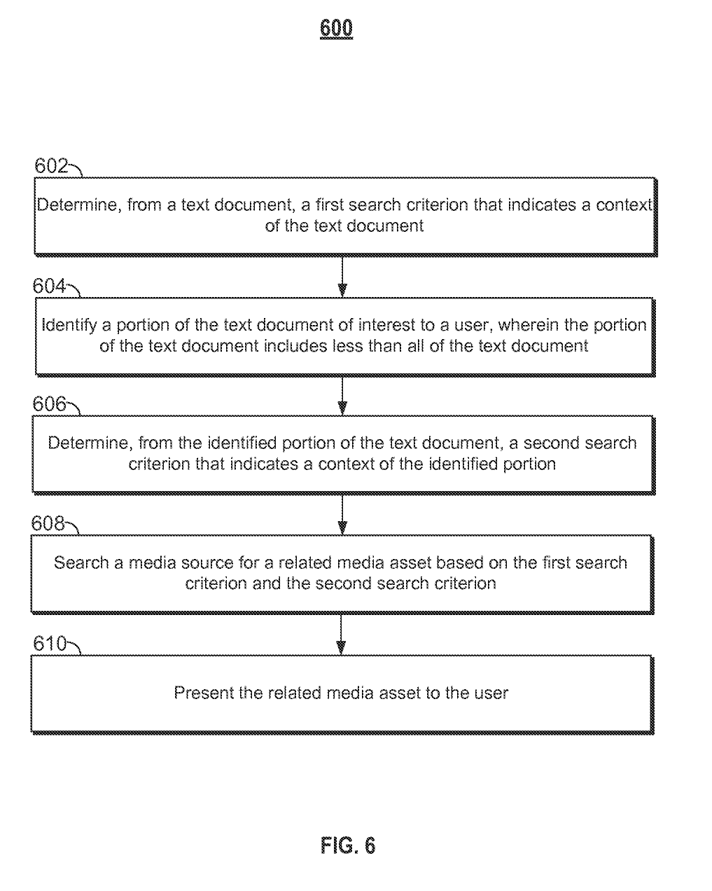

FIG. 6 is a flowchart of illustrative steps for providing context-specific media assets based on a first and second search criterion. Process 600 includes determining, from a text document, a first search criterion that indicates a context of a text document at step 602, identifying a portion of the text document of interest to a user, in which the portion of the text document includes less than all of the text document at step 604, determining, from the identified text portion of the text document, a second search criterion that indicates a context of the identified portion at step 606, searching a media source for a related media asset based on the first search criterion and the second search criterion at step 608, and presenting the related media asset to the user at step 610.

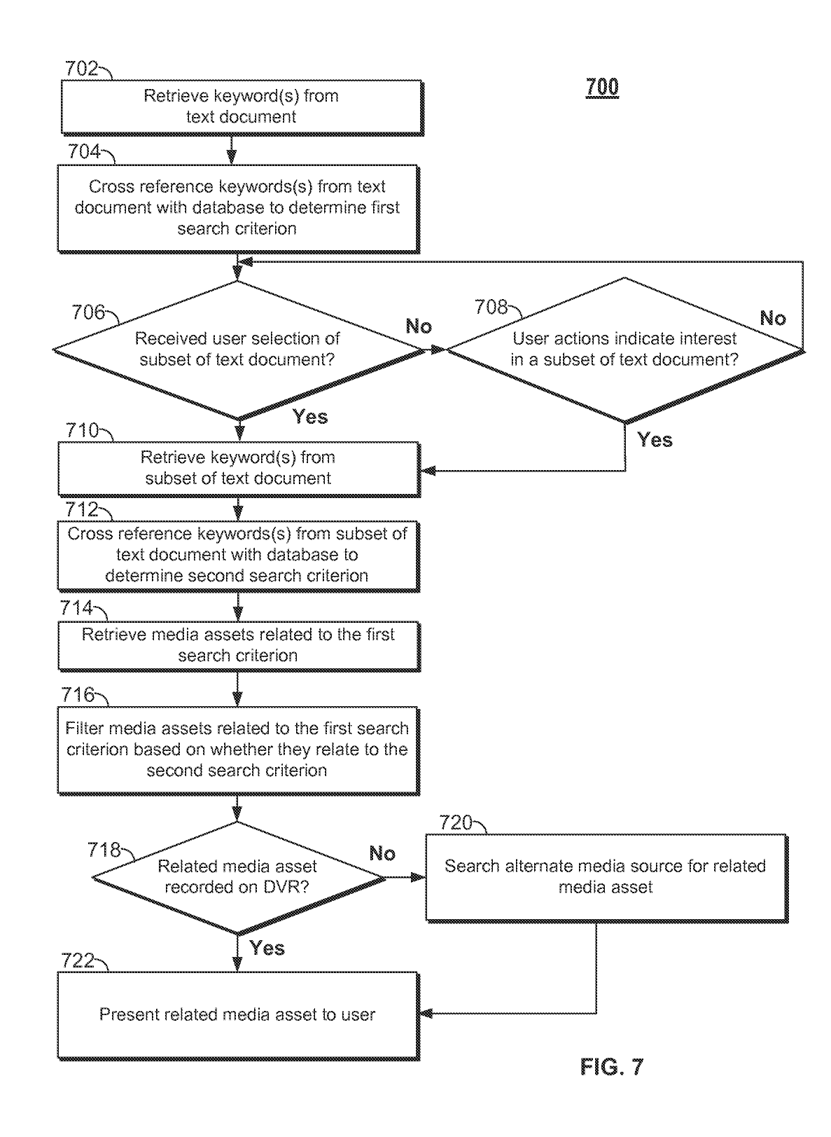

Although the illustrative examples described in FIGS. 6 and 7 are discussed in relation to text media assets, it will be understood that the systems and methods disclosed herein for providing context-specific media assets may be applied to any type of media asset that the user may be consuming, including, but not limited to, text documents, sound recordings or other audio, and video media assets.

At step 602, a media guidance application may determine (e.g., via control circuitry 304 (FIG. 3)), from a text document, a first search criterion that indicates a context of a text document. As discussed above, the context of the text document may be include, but is not limited to, a subject matter of the media asset, a category of the media asset, a genre of the media asset, or a context of the media asset. For example, the user may be reading a news article about a political election, and the first search criterion may comprise the keyword “politics”. In addition to keywords, the first search criterion may also include search parameters that narrow the number of retrieved media assets. For example, the first search criterion may include a parameter for “news” such that only news articles may be retrieved. In alternate embodiments, “news” may be included as a separate keyword in the first search criterion.

The media guidance application may determine the first search criterion in any number of ways. In some embodiments, the media guidance application may perform a keyword search (e.g., via control circuitry 304 (FIG. 3)) of the text document to retrieve keyword terms. In some embodiments, the text document may be associated with a content tag that describes the content of the text document. For example, the news article may be pre-sorted into the “politics” category of a news webpage. The media guidance application may determine from the content tag that the article is in the politics category.

At step 604, the media guidance application may identify (e.g., via control circuitry 304 (FIG. 3)) a portion of the text document of interest to a user, in which the portion of the text document includes less than all of the text document. The media guidance application may identify the portion of interest in a number of ways. In some embodiments, the media guidance application may receive a user input (e.g., through user input interface 310 (FIG. 3)) indicating interest in a portion of the text document. For example, the user may highlight a sentence of the text document with a mouse or keyboard cursor. In other embodiments, the text document may include user-selectable portions or buttons, and the user may select these portions in order to indicate interest in the portion. The media guidance application may also implicitly determine a user's interest in a portion of the text document. As discussed above in relation to FIG. 5, the media guidance application may track a user's gaze and eye movement (e.g., using detection module 316 (FIG. 3)) to determine that the user is reading a particular portion of the text document. The media guidance application may also detect the user's facial expressions, movements, and/or any sound and utilize any combination of these sensor measurements (e.g., via detection module 316 (FIG. 3)) to determine a user's interest. As an illustrative example, the user may be reading a particular sentence of a text article and suddenly exclaim loudly and high-five a second user. The media guidance application may detect the sudden movement and increase in sound volume and determine that the particular sentence, which was identified using the user's eye gaze, is of particular interest to the user.

At step 606, the media guidance application may determine (e.g., via control circuitry 304 (FIG. 3)), from the identified text portion of the text document, a second search criterion that indicates a context of the identified portion. The media guidance application may determine the second search criterion in a substantially similar way as determining the first search criterion. For example, the media guidance application may perform a keyword search on the identified portion of interest. The second search criterion may also include a time or time period parameter that was identified from the portion of interest. For example, the identified text portion may indicate that a particular event occurred at a certain time, and the time may be added to the second search parameter. In some embodiments, the second search criterion may be narrower or be used to identify a subset of media assets that are related to the first search criterion. For example, the second search criterion may be used to narrow a set of media assets that are related to the first search criterion.

At step 608, the media guidance application may search (e.g., via control circuitry 304 (FIG. 3)) a media source (e.g., storage 308 (FIG. 3), media content source 416 (FIG. 4), media guidance data source 418 (FIG. 4), and/or any location accessible via communications network 414 (FIG. 4)) for a related media asset based on the first search criterion and the second search criterion. The media guidance application may search one or more media sources, including, but not limited to, the user's DVR, a networked DVR, a broadcast source, a video-on-demand source, a pay-per-view source, a streaming source, or an Internet media source (e.g., Youtube). In some embodiments, the first search criterion and the second search criterion may be combined to perform a single search that matches both criterion. In alternate embodiments, the media source(s) may be searched for media assets that are related to the first search criterion, and the results may be filtered by the second criterion. The filtered results may represent a subset of the media assets related to the first search criterion.

In some embodiments, the media guidance application may search the media source automatically without further user input. For example, the media source may identify a portion of the text document of interest to the user and automatically search for related media assets according to the first and second search criterion. In other embodiments, the media guidance application may search the media source(s) in response to identifying the portion of the media asset of interest to the user. For example, a search on Youtube may be performed in response to the user highlighting a sentence of a text document.

At step 610, the media guidance application may present the related media asset (e.g., via control circuitry 304 (FIG. 3)) to the user at step 610 (e.g., using display 312 (FIG. 3)). In some embodiments, the media guidance application may present the related media asset and query the user whether the user wishes to play the related media asset. In other embodiments, the media guidance application may present a list of related media assets that were retrieved based on the first and second search criterion. The user may be able to select one of the related media assets from the list (e.g., via user input interface (FIG. 3)) to generate for display on a display device. The media asset or list of related media assets may be presented to the user in any suitable method and in any location on a display device, such as display 312 (FIG. 3). For example, the related media asset or list of related media assets may presented as a sidebar, as a banner at the top or bottom of a display screen, as a popup, as a picture-in-picture (PIP), a partial overlay, a full-screen overlay, or in any other suitable location or size. In some embodiments, the media guidance application may automatically play the related media asset. In embodiments where a list of related media assets are presented to the user, the media guidance asset may present a playlist and automatically begin playing a first related media asset in the playlist of media assets.

In some embodiments, the related media asset may be a portion or clip of a full media asset. For example, the related media asset may be a portion of a tv show. In such embodiments, the media guidance application may crop (e.g., via control circuitry 304 (FIG. 3)) a complete media asset to generate the related media asset. In such embodiments, the user may select a desired length of such cropped portions, either in real-time or in a prior selection (such as a user profile). The media guidance application may store the user's preferences, for example at storage 308 (FIG. 3) and/or any location accessible via communications network 414 (FIG. 4). For example, such a feature may allow the media guidance application to provide “highlights” of a sports game which show only the most exciting moments in the sports game. In some embodiments, the media guidance application may search a user's DVR, networked DVRs, or any other location accessible via communications network 414 (FIG. 4) for the complete media asset. In response to finding the complete media asset, the media guidance application may automatically crop the complete media asset based, at least in part, on the first and the second search criterion. In some embodiments, the media guidance application may automatically begin playback at an intermediate time within the complete media asset based, at least in part, on the first and the second search criterion.

FIG. 7 is a process 700 which shows illustrative steps for determining a subset of a text document of interest to a user and presenting a related media asset to the user in accordance with some embodiments of the disclosure.

At step 702, a media guidance application may retrieve a keyword or keywords (e.g., via control circuitry 304 (FIG. 3)) from a text document. As discussed in relation to step 602 of FIG. 6, the keyword or keywords may be retrieved in many ways. For example, the media guidance application may perform a keyword search (e.g., via control circuitry 304 (FIG. 3)) on the text document. The media guidance application may also retrieve the keyword(s) from a portion of the text document, such as the title or a summary/synopsis. At step 704, the media guidance application may cross reference the retrieved keywords from the text document with a database to determine first search criterion. The database may be any suitable database for storing and indexing search terms or parameters, and may be located at storage 308 (FIG. 3) and/or any location accessible via communications network 414 (FIG. 4). The database may contain a set of popular search terms that are periodically updated to reflect common search terms related to media assets. The media guidance application may retrieve keywords from the text document that match entries in the database to determine the first search criterion.

At step 706, the media guidance application may determine (e.g., via control circuitry 304 (FIG. 3)) whether a user selection of a subset of the text document has received. For example, as discussed above in relation to step 604 of FIG. 6, the media guidance application may determine whether the user has highlighted a subset of the text document. If no user selection has been received, the media guidance application may continue to step 706 and monitor the user's actions (e.g., via control circuitry 304 (FIG. 3)) and determine whether they indicate an interest in a subset of a text document. For example, as discussed above, the media guidance application may track the user's eye gaze, physical movements, sounds, or any combination of the above using detection module 316 to determine a user's interest in a subset of the text document. If no interest is detected, the media guidance application may return to step 706.

If either a user selection or a user action that indicates interest is detected, the media guidance application may retrieve keyword(s) from the subset of the text document at step 710. The media guidance application may retrieve keyword(s) from the subset of the text document in substantially the same way as from the full text document. At step 712, the media guidance application may cross reference (e.g., via control circuitry 304 (FIG. 3)) the keyword(s) from the subset of the text document with a database to determine second search criterion. The database used in step 712 may be the same or different than the database used in step 704. In some embodiments, the first search criterion and the second search criterion may be directed to different search parameters. For example, the first search criterion may indicate a genre of the text document, and the second search criterion may include further details from the text document, such as specific people mentioned in a subset of the text document, or a time associated with an event that is discussed in the text document. In such embodiments, the database in step 704 may include a list of potential genres, such as “sports,” “news,” local,” “romance,” etc. while the database in step 712 may include potential names of people or relevant times.

At step 714, the media guidance application may retrieve (e.g., via control circuitry 304 (FIG. 3)) one or more media assets related to the first search criterion. The media guidance application may retrieve the assets in any suitable manner, including, but not limited to, searching the user's DVR, searching a networked DVR (either in the same household or in networked households), or performing a search on one or more media sources (such as media content source 416 and/or any other location accessible via communications network 414 (FIG. 4)). At step 716, the media guidance application may filter (e.g., via control circuitry 304 (FIG. 3)) the media assets related to the first search criterion based on whether they relate to the second search criterion. In some embodiments, the media assets related to the first and the second search criterion may be a subset of the media assets related to the first search criterion.

At step 718, the media guidance application may determine (e.g., via control circuitry 304 (FIG. 3)) whether a media asset related to the first and the second search criterion is recorded on the user's DVR. If a related media asset is not recorded, the media guidance application may, at step 720, search alternate media source(s), such as media content source 416 or any other location accessible via communications network 414 (FIG. 4), for a related media asset. For example, the media guidance application may search broadcast sources, VOD sources, Internet sources, or any other media source for the related media asset. Once a related media asset is found, at either step 718 or 720, the related media asset may be presented to the user at step 722. The related media asset or assets may be presented to the user at step 722 in substantially the same way as in step 610.

The above-described embodiments of the present disclosure are presented for purposes of illustration and not of limitation, and the present disclosure is limited only by the claims that follow. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A method for providing a media asset, comprising:
determining, from a text document, a first search criterion that indicates a context of the text document;
identifying a portion of the text document of interest to a user, wherein the portion of the text document includes less than all of the text document;
determining, from the identified portion of the text document, a second search criterion that indicates a context of the identified portion;
searching a media source for a related media asset based on the first search criterion and the second search criterion; and
presenting the related media asset to the user.

2. The method of claim 1, wherein searching the media source for the related media asset based on the first search criterion and the second search criterion further comprises:
retrieving media assets related to the first search criterion; and
filtering the media assets related to the first search criterion based on whether the media assets relate to the second search criterion.

3. The method of claim 1, wherein media assets that are related to the second search criterion are a subset of the media assets that relate to the first search criterion.

4. The method of claim 1, wherein identifying the portion of the text document of interest to the user comprises receiving a user input that highlights the portion of the text document.

5. The method of claim 1, wherein identifying the portion of the text document of interest to the user comprises identifying the portion of the text document by tracking the eye movement of the user.

6. The method of claim 1, wherein identifying the portion of the text document of interest to the user comprises monitoring a facial expression of the user.

7. The method of claim 1, further comprising identifying a time associated with the portion of the text document, and wherein the second search criterion comprises the identified time.

8. The method of claim 7, wherein presenting the related media asset comprises beginning playback of the related media asset at an intermediate time within the related media asset based on the identified time.

9. The method of claim 1, wherein the related media asset comprises a portion of a complete media asset, and wherein presenting the related media asset comprises cropping the complete media asset.

10. The method of claim 9, wherein the complete media asset is cropped to a length that is selected by the user.

11. A system for providing a media asset, comprising:
control circuitry configured to:
determine, from a text document, a first search criterion that indicates a context of the text document;
identify a portion of the text document of interest to a user, wherein the portion of the text document includes less than all of the text document;
determine, from the identified portion of the text document, a second search criterion that indicates a context of the identified portion;
search a media source for a related media asset based on the first search criterion and the second search criterion; and
present the related media asset to the user.

12. The system of claim 11, wherein the control circuitry is configured to search the media source for the related media asset based on the first search criterion and the second search criterion by:
retrieving media assets related to the first search criterion; and
filtering the media assets related to the first search criterion based on whether the media assets relate to the second search criterion.

13. The system of claim 11, wherein media assets that are related to the second search criterion are a subset of the media assets that relate to the first search criterion.

14. The system of claim 11, wherein the control circuitry is configured to identify the portion of the text document of interest to the user by receiving a user input that highlights the portion of the text document.

15. The system of claim 11, wherein the control circuitry is configured to identify the portion of the text document of interest to the user by identifying the portion of the text document by tracking the eye movement of the user.

16. The system of claim 11, wherein the control circuitry is configured to identify the portion of the text document of interest to the user by monitoring a facial expression of the user.

17. The system of claim 11, wherein the control circuitry is further configured to identify a time associated with the portion of the text document, and wherein the second search criterion comprises the identified time.

18. The system of claim 17, wherein the control circuitry is configured to present the related media asset by beginning playback of the related media asset at an intermediate time within the related media asset based on the identified time.

19. The system of claim 11, wherein the related media asset comprises a portion of a complete media asset, and wherein the control circuitry is configured to present the related media asset by cropping the complete media asset.

20. The system of claim 19, wherein the complete media asset is cropped to a length that is selected by the user.

21-50. (canceled)
